(19) United States
(12) Patent Application Publication
(10) Pub. No.: US 2011/0037376 A1
(43) Pub. Date: Feb. 17, 2011

(54) LUMINOUS DEVICE

(75) Inventors: Maarten Marinus Johannes Wilhelmus Van Herpen, Eindhoven (NL); Michel Cornelis Josephus Marie Vissenberg, Eindhoven (NL); Marcellinus Petrus Carolus Michael Krijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/988,019

(22) PCT Filed: Apr. 16, 2009
(86) PCT No.: PCT/IB09/51579

§ 371 Date: Oct. 15, 2010

(30) Foreign Application Priority Data
Apr. 23, 2008 (EP) 08155016.2

(51) Int. Cl. H01J 1/62

(52) U.S. Cl. 313/483

(57) ABSTRACT

The present invention relates to a luminous device (1), comprising a light source (2) for emitting source light of a source wavelength, wherein the intensity of the source light is controllable by a signal. The device further comprises a first phosphor material (3, 4) capable of converting at least part of the source light to light of at least a first wavelength, and a second phosphor material (3, 4) capable of converting at least part of the source light to light of at least a second wavelength. The first and second phosphor materials (3, 4) are arranged to have a first and second conversion efficiency, respectively, that are controllable by the signal. The ratio of intensities of light of the first and second wavelength, respectively, is dependent on the signal. Furthermore, the present invention relates to an LED bulb, an LED package and a lighting system comprising a luminous device according to embodiments of the present invention.

### FIELD OF THE INVENTION

The present invention relates to the field of lighting devices, in particular to a luminous device, comprising a light source for emitting source light of a source wavelength, wherein the intensity of the source light is arranged to be controllable by a signal. Furthermore, the present invention relates to a lighting system, an LED bulb and a LED package, comprising a luminous device according to embodiments of the present invention.

### BACKGROUND OF THE INVENTION

In a near future, it is expected that incandescent lamps will be phased out, mainly due to their high-energy consumption. There are several alternative, potential replacement light sources, such as fluorescent lamps, light emitting diodes (LEDs) emitting white light, which are more energy efficient than incandescent lamps. It is important that the replacement light sources imitate the behavior of incandescent lamps, i.e. the replacement light source should, preferably, have similar properties as an incandescent lamp. For example, when dimming the light emission from the replacement light source it may be desired that the light emission shift towards a “warmer” color temperature. A replacement light source, having fulfilled these properties, may be accepted as an incandescent lamp replacement.

White light emitting LED chips are often combined with phosphors or a mixture of different phosphors. The phosphors or the phosphor mixtures add a color component to the light emitted from the LED, thereby resulting in the emission of white light. For example, by covering an LED emitting blue light with a phosphor, which adds red and yellow-green components, the emitted light will appear as a white light. White light emissions of different color temperatures may be achieved by the application of different phosphors or phosphors mixtures.

The color temperature of a light source relates to the temperature of a black-body radiator radiating light of a wavelength that corresponds to the color of the object. In this manner, any color may be represented by a number on a temperature scale, such as a Kelvin scale. An object, having a color of a high color temperature, is perceived as being blueish, often being described as a “cold” color. If an object has a low color temperature, it is visually more red, and may be described as an object with a “warm” color. Throughout this disclosure, the expressions “warm” and/or “cold” refer to low and high color temperatures, respectively. For example, a “warm” phosphor emits light of a low color temperature (i.e. long wavelengths), the emission thereof is accordingly perceived as visually pleasant. Notably, contrary to cultural associations, a color, which is perceived as “warm”, such as red, is represented by a low color temperature.

In US-patent 2007/0045761 A1, there is disclosed a technique for forming a white light emitting LED by coating a reflection cup surrounding a LED die with two different phosphors layers. A first layer, comprising a yellow-green phosphor, produces light emission of a high color temperature, while a second layer, comprising a red phosphor, produces light emission of a low color temperature (i.e. “warmer” white light). The coating techniques described are highly controllable. As a result, the phosphor coating is predictable, and thereby uniform white light may be emitted from the LED. A problem of this kind of LED is that the color temperature of the emitted light is determined in the stage of manufacturing of the LED.

Moreover, it is known that the color temperature of an incandescent lamp, while dimming the light intensity of the lamp, shifts towards “warmer” colors, i.e. lower color temperatures. Prior art LEDs, capable of emitting white light, do not have the same behavior, instead the color temperature of emitted light remains substantially unaltered or may even slightly increase. Hence, there is a need for an LED that imitates the behavior of an incandescent lamp, especially the behavior of the incandescent lamp when the light is dimmed, whereby the color temperature decreases.

### SUMMARY OF THE INVENTION

An object of the present invention is to alleviate at least one of the problems of prior art.

This and other objects are met by the luminous device, the LED bulb, the LED package and the lighting system as set forth in the appended independent claims. Specific embodiments are defined in the dependent claims.

According to an aspect of the invention, a luminous device comprises a light source for emitting source light of a source wavelength, the intensity of the source light being controllable by a signal. The device further comprises a first phosphor material capable of converting at least part of the source light to light of at least a first wavelength, being different from the source wavelength, and a second phosphor material capable of converting at least part of the source light to light of at least a second wavelength, being different from the source wavelength and the first wavelength. Furthermore, the first and second phosphor materials are arranged to have a first and second conversion efficiency, respectively, the first conversion efficiency being different from the second conversion efficiency, each conversion efficiency being controllable by the signal, whereby ratio of intensities of light of the first and second wavelength, respectively, is dependent on the signal.

An idea of the present invention is to provide a luminous device, comprising a light source, a first phosphor material of a first type and a second phosphor material of a second type. Intensity of light from the light source is arranged to be controlled by a signal, preferably a drive signal. The first and second type of phosphor material are different from each other, thereby being capable of converting light from the light source to light of a respective wavelength (or wavelength range). Moreover, at least one of the first and second phosphor materials is arranged to have a conversion efficiency that is affected (changed) by a property being dependent on the intensity of the source light. This change in efficiency should be different for the first and second phosphor materials. In this manner, color temperature of the total light from the luminous device may be controlled, wherein the total light comprises a mixture of light originating directly from the light source and light being converted by the first and second phosphor material. Advantageously, there is provided a luminous device, wherein the color temperature of the light emission from the luminous device may be controlled merely by changing a signal used for intensity control, i.e. no additional electronic circuits are required to be able to control the color temperature of the luminous device.

In another aspect of the present invention, there is provided a LED bulb comprising the device according to embodiments of the present invention. It is preferred to locate the phosphor materials at a casing of the LED bulb, i.e. the phosphors are located at a distance (remote) from the light source of the luminous device. Advantageously, the LED bulb may be used in existing luminaires without need for modification thereof.

In a further aspect of the present invention, there is provided a LED package comprising the device according to embodiments of the present invention. It is preferred to locate the phosphor materials nearby the light source of the luminous device. Advantageously, a component for mounting on a PCB or the like is provided.

In yet another aspect of the present invention, there is provided a lighting system comprising the device according to embodiments of the present invention.

Furthermore, the light source may be an LED structure (LED die or LED chip), such as a GaInN blue LED, a GaInN UV LED, a fluorescent lighting element, a combination thereof or the like. Preferably, the light source is able to pump a phosphor that is capable of emitting light in the visible spectrum. This implies that the pumped wavelength is shorter than the wavelength (or wavelengths) emitted by the phosphor. A shorter wavelength corresponds to higher photon energies and vice versa. The difference in photon energy used for pumping and the photon energy of the light emitted by the phosphor is converted into heat. The larger this difference is, the less efficient the conversion process is. However, a large difference means that it is easy to heat the phosphor and, thereby induce temperature dependent effects.

It is to be noted that the first and second phosphor material are matched to the wavelength of the light source. It is matched in such a manner that for a change in temperature of the phosphor material or a change of the wavelength of light incident on the phosphor material, a change in conversion efficiency of the phosphor material is obtained. For example, garnet fluorescent material activated by cerium, yttrium-aluminum-garnet fluorescent material activated by cerium, or the like may be used in the present luminous device. Other examples are cerium-doped calcium-aluminum-silicate and cerium-doped or praseodymium-doped lutetium-aluminum-garnet. Advantageously, by selecting suitable phosphor materials, the effect of the conversion efficiency change, due to change of a property that is dependent on the intensity of the source light, may be increased.

In contrast to the luminous device according to embodiments of the present invention, for prior art white LED systems, the combination of phosphor materials and LED emission wavelength is chosen such that the phosphor has a maximum efficiency, and as a result a wavelength shift in the LED emission output wavelength results in a wavelength shift that is as low as possible. Thus, prior art white LED systems are using an LED emission wavelength that is as close as possible to a phosphor absorption peak (i.e. where the phosphor has a, possibly local, maximum absorption value).

In embodiments of the luminous device according to the present invention, a change of the intensity of the source light may, for example, induce a change in wavelength of the source light or a change in temperature of the at least one of the first and second phosphor material. In this manner, since light conversion efficiency of at least one of the phosphor materials is dependent on the temperature thereof and/or wavelength of incident light (originating from the light source), the ratio of light converted by the first and second phosphor material and, optionally, non-converted light changes.

In another embodiment of the luminous device according to the present invention, at least one of the first and second conversion efficiency may be dependent on the source wavelength, the source wavelength being dependent on the intensity of the source light. In this manner, there is made use of the effect that when the intensity of the source light changes, the wavelength of the source light also changes. As a result, since the conversion efficiency of at least one of the first and second phosphor material may change due to a change in wavelength of the source light, intensity of light converted by the at least one of the first and second phosphor material may change as well. Thus, also color temperature of the total light from the luminous device changes. For example, the wavelength dependent phosphor material may be selected such that when the intensity of the light source (e.g. the LED) is deceased (the wavelength of the LED shifts towards shorter wavelengths) the color temperature of the light emission (as a mixture of converted and non-converted light) from the luminous device also decreases (i.e. a light emission that is perceived as “warm” may be achieved). All phosphors (or phosphor materials) have a wavelength dependent conversion efficiency. Thus, all phosphors are suited for this invention, as long as suitable phosphors are chosen for a specific LED wavelength. Examples of suitable phosphor materials, include, but are not limited to, garnet fluorescent material activated by cerium, yttrium-aluminum-garnet fluorescent material activated by cerium.

In a further embodiment of the present luminous device, at least one of the first and second conversion efficiency may be dependent on temperature of the first and second phosphor material, respectively, the temperature being dependent on the intensity of the source light. In this manner, there is made use of the effect that when the intensity of the source light changes, the temperature of the light source (and materials that may be located in the vicinity thereof) also changes. As a result, since the conversion efficiency of at least one of the first and second phosphor material may change due to a change in temperature, intensity of light converted by the at least one of the first and second phosphor material may change as well. Thus, also color temperature of the total light from the luminous device changes. All phosphors are temperature dependent (due to thermal quenching), but the conversion efficiency of some phosphors is more affected than the conversion efficiency of other phosphors. Local temperature differences in the phosphor materials or difference in temperature dependence make be utilized to obtain color variation of the light emitted from the luminous device according to embodiments of the present invention. Examples of phosphor materials, whose conversion efficiency is temperature dependent, include, but are not limited to garnet fluorescent material activated by cerium, yttrium-aluminum-garnet fluorescent material activated by cerium, cerium-doped calcium-aluminum-silicate and cerium-doped or praseodymium-doped lutetium-aluminum-garnet or the like may be used in the present luminous device.

In yet another embodiment of the luminous device according to the present invention, the luminous device may further comprise a transparent housing, wherein at least one of the first and second phosphor material may be located at the housing. In this manner, since the phosphor materials may be located at (or incorporated in) the housing, the housing of the luminous device provides for some of the optical properties of the luminous device. Hence, a first luminous device, comprising a first housing and a first light source, may have different optical properties than a second luminous device, comprising a second housing and the first light source (i.e. the same type of light source as the first luminous device).

Moreover, according to yet other embodiments of the present invention, there may be provided a luminous device, wherein a first layer comprises the first phosphor material. Optionally, according to embodiments of the present luminous device, a second layer may comprise the second phosphor material. As a result, a specific selection of layers comprising different phosphor materials determines the optical properties of the luminous device.

According to yet another embodiment of the invention, there is provided a luminous device, wherein the second layer may be disposed between the first layer and the light source. Optionally, the first and second layer may be stacked at the light source. Advantageously, light conversion in the first layer may increase, when the second layer is saturated.

In another embodiment of the luminous device according to the present invention, the first layer further comprises the second phosphor material. In this manner, the first layer comprises a mixture of a first and second phosphor material. Advantageously, manufacturing may be facilitated.

Furthermore, in embodiments of the luminous device according to the present invention, there is provided a luminous device further comprising additional electronic circuits, arranged to provide different pulse-modulation driving schemes. In this manner, control of the color temperature and the intensity of the light from the luminous device are obtained. For example, when the pulse-modulation scheme comprises very short, but high pulses, the temperature in the LED die reaches higher levels than the levels reached by a pulse-modulation scheme comprising longer, but lower pulses. In this manner, temperature difference may be used to tune the color temperature without changing the output intensity of the LED.

Further features of, and advantages with, the present invention will become apparent when studying the appended claims and the following description. Those skilled in the art realize that different features of the present invention may be combined to create embodiments other than those described in the following, without departing from the scope of the present invention as defined by the appended independent claims.

### BRIEF DESCRIPTION OF THE DRAWINGS

The various aspects of the invention, including its particular features and advantages, will be readily understood from the following detailed description and the accompanying drawings, in which:

FIG. 1 shows a cross-sectional, side view of a luminous device according to an embodiment of the present invention,

FIG. 2 shows a cross-sectional, side view of a luminous device according to another embodiment of the present invention,

FIG. 3 shows two graphs of the conversion efficiency spectra from two different phosphor materials,

FIG. 4 shows the excitation spectra of phosphor materials, disclosed in U.S. Pat. No. 5,998,925, which are suitable for use with embodiments of the present invention,

FIG. 5 shows the emission spectra of the phosphor materials, disclosed in U.S. Pat. No. 5,998,925, whose excitation spectra are shown in FIG. 4,

FIG. 6 shows a luminous device according to a further embodiment of the present invention, and

FIG. 7 shows a luminous device according to yet another embodiment of the present invention.

### DETAILED DESCRIPTION OF EMBODIMENTS

Throughout the following description similar reference numerals have been used to denote similar elements, parts, items or features, when applicable.

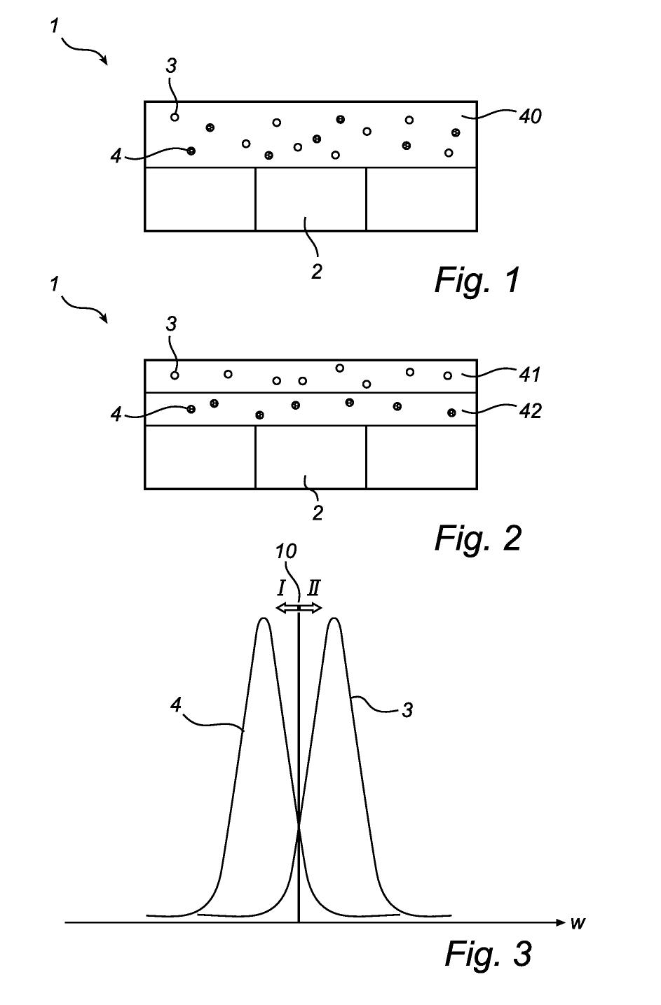

In FIG. 1, there is shown an exemplifying embodiment of the luminous device according to the present invention. The luminous device 1 comprises a LED chip 2, a layer 40 comprising a “cold” phosphor material 3 and a “warm” phosphor material 4. For an increase of the current through the LED chip 2, the efficiency of the “cold” and “warm” phosphor material change, such that the ratio of “cold” and “warm” emission changes. Preferably, a higher LED current (i.e. higher intensity) results in a higher proportion “cold” emission (high color temperature) as compared to “warm” emission (low color temperature). In this manner, the overall light emission from the luminous device 1 appears “colder” for a higher LED current.

FIG. 2 illustrates a further embodiment of the luminous device according to the present invention, wherein the luminous device comprises a first and a second layer 41, 42. The first layer 41 comprises phosphor materials 3, and the second layer 42 comprises phosphor material 4. In this manner, the phosphor material 3 of the first layer 41 may be inactive as long as the phosphor material 4 of the second layer 42 is not saturated. Not until the intensity of the emission of the LED chip 2 no longer is absorbed by the phosphor material 4 of the second layer, the phosphor material 3 of the first layer begins to convert light emission from the LED chip 2. Thereby, the color temperature of the light emission from the luminous device 1 may be controlled by the signal for controlling intensity of the overall light emission from the luminous device 1.

Referring to FIG. 3, two graphs of conversion efficiency spectra for a “cold” and a “warm” phosphor material 3, 4, respectively, are demonstrated. Wavelength is along the abscissa and light intensity is along the ordinate. The line 10 denotes peak output wavelength of an LED chip. The temperature of the semiconductor junction in the LED is dependent on the output intensity, i.e. high intensity corresponds to high temperature. When the junction temperature goes up, the output wavelength 10 of the LED shifts to longer wavelengths (the output wavelength is moved in direction II, towards lower color temperatures). For example, when the junction temperature increases from 20° to 100 ° C., the output wavelength shifts from 459 nm to 467 nm for a GaInN blue LED, or from 373 nm to 378 nm for a GaInN UV LED as is described in “Influence of junction temperature on chromaticity and color-rendering properties of tri-chromatic white-light sources based on light-emitting diodes”, J. Appl. Phys. 97, 054506 (2005) by S. Chhajed et al. Similarly, when the junction temperature goes down, a shift towards shorter wavelengths (the output wavelength is moved in direction I, towards higher color temperatures) occurs. As may be seen from the Figure, for a shift towards longer wavelengths (II), conversion efficiency of the “cold” phosphor material 3 increases, whereas the conversion efficiency of the “warm” phosphor material 4 decreases. As a result, the “warm” phosphor material 4 dominates for low LED output levels and the “cold” phosphor material 3 dominates for high LED output levels, thereby the behavior of the luminous device 1 is more similar to an incandescent lamp than conventional LEDs. Hence, the luminous device 1 is well suited as a replacement for an incandescent lamp.

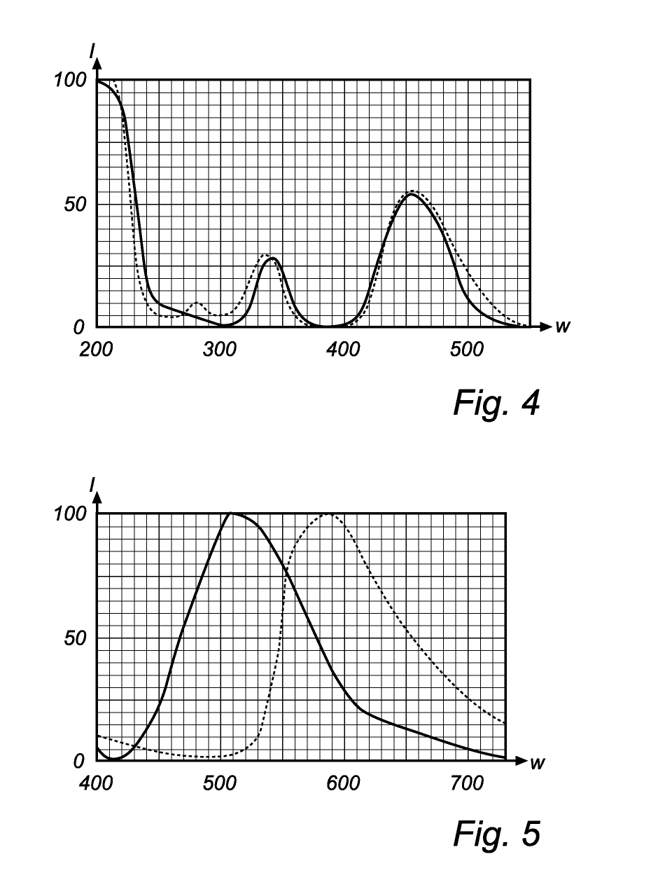

FIG. 4 shows some examples of excitation spectra of phosphors. It can be seen that in this case the phosphors typically have a maximum absorption peak (in FIG. 4 at around 455 nm) and the absorption goes down with an increasing rate when going away from this maximum.

However, with the luminous device according to embodiments of the present invention the combination of LED emission and phosphor is chosen such that at least one of the phosphors is excited at a wavelength where a wavelength shift has a significant impact. In the examples of FIG. 4, suitable excitation wavelengths would be around 490 nm, or around 430 nm, since a small wavelength change results in a large change in intensity at these wavelength values. Typically, the largest effect may be obtained at half-maximum of the absorption peak.

For a typical phosphor the dependence of the absorption on the wavelength may decrease by a factor of 2.5 with a wavelength shift of 10 nm, for example, from 50% to 20% of the intensity at peak excitation. For a temperature change of 50° C. (which is still harmless for the LED) the wavelength shift of the LED will be around 2 nm, resulting in an absorption difference of, for example, from 26% to 20%, which is a 23% change in contribution from the affected phosphor. By combining the efficiency change of two phosphors (one going up and the other going down in efficiency), the relative efficiency change between the phosphors may be up to 50% for a temperature change of 50° C. This is sufficient to significantly change the color temperature of the luminous device.

In a further embodiment of the luminous device according to the present invention, the phosphor materials are selected such that the behavior of the present luminous device is opposite to that of an incandescent lamp. In other words, the color temperature of the light converted by the phosphor materials goes down for an increased light intensity. In this manner, a luminous device with a constant color temperature for varying light intensities may be provided. Phosphor materials that are suitable for such an embodiment are shown in FIGS. 4 and 5.

In FIG. 5, there is shown emission spectra of a “cold” and “warm” phosphor material. The “cold” phosphor material (the solid line) is a garnet fluorescent material activated by cerium having a maximum emission peak at 510 nm (green), and the “warm” phosphor (the dashed line) is a yttrium-aluminum-garnet fluorescent material activated by cerium having a maximum emission peak at 585 nm (yellow). Notably, the “warm” phosphor material has a lower color temperature than the “cold” phosphor material.

In FIG. 4, the excitation spectra of a “cold” and “warm” phosphor material are plotted. The intensity of light (ordinate) versus wavelength (abscissa) is plotted. The solid line represents the “cold” phosphor material, whereas the dashed line represents the “warm” phosphor material. From FIG. 4, it may be seen that, for example, a wavelength shift from 490 nm to 500 nm results in a change in relative absorption intensity from 25% to 10% for the “cold” phosphor and from 30% to 25% for the “warm” phosphor. Hence, the opposite behavior as compared to an incandescent lamp is obtained with this configuration.

On the other hand, with the phosphors according to FIGS. 4 and 5, the behavior as in an incandescent lamp may be provided in a further example of the luminous device according to the present invention. From FIG. 4, it can be concluded that by increasing an LED wavelength from 338 nm to 345 nm (which occurs when the intensity is increased), the green (“cold”) phosphor (the solid line) increases from 25% to 27% whereas the yellow (“warm”) phosphor (the dashed line) decreases from 30% to 25%. This results in that the green (colder) light becomes more dominant, and the overall output light from the LED lamp shifts to blue (shorter wavelength). This is the same behavior as the incandescent lamp. Therefore, in this case, the dimming of the LED lamp shows a red shift as in incandescent lamps.

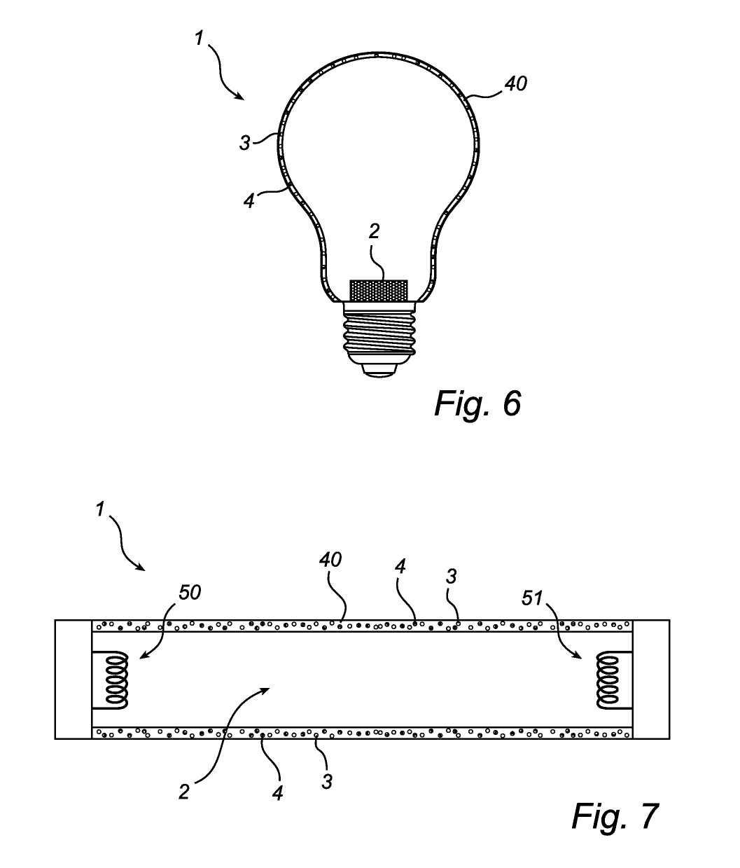

Furthermore, in FIG. 6, there is shown a further embodiment of the luminous device according to the present invention. The luminous device 1 comprises a light source 2, such as an LED chip or the like, a casing 40, which comprises a first and second phosphor material 3, 4. The first and second phosphor materials are located remotely from the LED chip. The casing is in the form of a conventional light bulb, but other shapes, such as in the shape of a cone, a cylinder, etc., may also be suitable. Advantageously, lighting systems (luminaries) for conventional light bulbs need not be modified, since the luminous device 1 fits in the place of a light bulb. As a result, the luminous device 1 may be used as a replacement for conventional light bulbs.

With reference to FIG. 7, there is shown yet another embodiment of the luminous device according to the present invention, wherein the luminous device is in the form of a conventional fluorescent tube. The luminous device 1 comprises an anode 50 and a cathode 51 for excitation of a gas 2, such as mercury, argon or krypton or the like as known in the art. A casing 40 comprises a first and a second phosphor material 3, 4 of a first and second type as described above. When operated, electrons from the cathode excite atoms of the gas 2, which in response thereto emit ultraviolet light for conversion by the phosphor materials 3, 4 to visible light of visible wavelengths. In aspects relating to the control of the color temperature of the emission from the luminous device 1, this embodiment is similar to the embodiments described above. Hence, explanation and description thereof are not repeated.

In still further embodiment of luminous device according to the present invention, the phosphors are chosen such that one phosphor is excited at its peak absorption (preferably this is a white, “cold” phosphor) and the other phosphor is excited at a point with high dependence on excitation wavelength (preferably this is a phosphor emitting, for example, red light). The advantage of this approach is that at high intensities (when the white, “cold” phosphor is dominating) the efficiency of the phosphor is high (for example at 98% of its peak excitation). At low intensities (when the power usage of the LED is much lower), the efficiency of the red phosphor goes up (for example from 10 to 25%) and the efficiency of the white phosphor stays approximately the same (for example from 98% to 100% of peak excitation), reducing the color temperature of the LED and at the same time giving a higher efficiency.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A luminous device, comprising:
a light source for emitting source light of a source wavelength, the intensity of the source light being controllable by a signal,
a first phosphor material capable of converting at least part of the source light to light of at least a first wavelength, being different from the source wavelength, and
a second phosphor material capable of converting at least part of the source light to light of at least a second wavelength, being different from the source wavelength and the first wavelength, wherein the first and second phosphor materials are arranged to have a first and second conversion efficiency, respectively, the first conversion efficiency being different from the second conversion efficiency, each conversion efficiency being controllable by the signal, whereby the ratio of intensities of light of the first and second wavelength, respectively, is dependent on the signal and wherein the source wavelength is selected such that at least one of the first and second phosphor materials is excited at a wavelength where a wavelength shift substantially impacts the emission output of the luminous device relative to a wavelength shift obtained with a source wavelength close to a maximum absorption value.

2. The device according to claim, wherein at least one of the first and second conversion efficiency is dependent on the source wavelength, the source wavelength being dependent on the intensity of the source light.

3. The device according to claim, wherein the first conversion efficiency is dependent on temperature of the first phosphor material, the temperature being dependent on the intensity of the source light.

4. The device according to claim 1, wherein the second conversion efficiency is dependent on temperature of the second phosphor material, the temperature being dependent on the intensity of the source light.

5. The device according to claim 1, wherein the light source comprises an LED structure, a fluorescent lighting element or a combination thereof.

6. The device according to claim 1, wherein the device further comprises a transparent housing, at least one of the first and second phosphor material being located at the housing.

7. The device according to claim 1, wherein a first layer comprises the first phosphor material.

8. The device according to claim 1, wherein a second layer comprises the second phosphor material.

9. The device according to claim 7, wherein the second layer is disposed between the first layer and the light source.

10. The device according to claim 7, wherein the first layer further comprises the second phosphor material.

11-13. (canceled)

14. The device according to claim 1, wherein the source wavelength is selected to be within a 20 nm interval, which does not include a maximum absorption value of the first or second phosphor materials.

15. The device according to claim 1, wherein the source wavelength is about one half of a maximum absorption value of the first or second phosphor materials.
